(19) United States
(12) Patent Application Publication
(10) Pub. No.: US 2025/0196481 A1
(43) Pub. Date: Jun. 19, 2025

(54) PP-Industrial-Reclaimed-PP-Containing Transparent OPP Films

(71) Applicant: Treofan Germany GmbH & Co. KG, Neunkirchen (DE)

(72) Inventor: Bertram Schmitz, Saarbrücken (DE)

(73) Assignee: Treofan Germany GmbH & Co. KG, Neunkirchen, SL (DE)

(21) Appl. No.: 19/067,851

(22) Filed: Mar. 1, 2025

Related U.S. Application Data
(63) Continuation of application No. PCT/IB2024/051427, filed on Feb. 15, 2024.
(60) Provisional application No. 63/447,363, filed on Feb. 22, 2023.
(60) Provisional application No. 63/526,210, filed on Jul. 12, 2023.
(60) Provisional application No. 63/548,411, filed on Nov. 14, 2023.

(51) Int. Cl. B32B 27/08; B32B 27/18; B32B 27/32; B32B 27/36; C08F 10/06

(52) U.S. Cl. CPC B32B 27/08; B32B 27/18; B32B 27/32; B32B 27/36; C08F 10/06; B32B 2264/104; B32B 2272/00; B32B 2307/30; B32B 2307/414; B32B 2307/514; B32B 2307/704; B32B 2519/00

(57) ABSTRACT

In one embodiment, the disclosure provides at least one layer (i.e., core layer and/or tie layer(s)) may include ≥about 5 wt. % through≤about 95 wt. % of a combination of virgin polypropylene and post-industrial reclaimed polypropylene, and has a melt flow index from about 0.5 g/min through about 15 g/min and a dispersion index from about 2 through 10, wherein filter pressure of the post-industrial reclaimed polypropylene≤about 20 bar/kg when using a 350-mesh filter on a COLLIN Teach Line Type FT-E20T extruder according to the method and settings in the description, wherein the oriented film is neither cavitated nor pigmented, and wherein the oriented film has a haze of about 50% or less.

### REFERENCE TO RELATED APPLICATIONS

This is a continuation application from and that claims priority to PCT application PCT/IB2024/051427 filed Feb. 15, 2024, which claims priority to U.S. provisional application No. 63/447,363 filed Feb. 22, 2023, U.S. provisional application No. 63/526,210 filed on Jul. 12, 2023, and U.S. provisional application No. 63/548,411 filed on Nov. 14, 2023, all of which are incorporated by this reference in their entireties.

### BACKGROUND

Today, a huge amount of polypropylene films exist as possible recycle from various converter and end-user applications. However, other than downgrading, it is generally not possible to reuse recycled scraps as materials biaxially oriented polypropylene (“BOPP”) films, such as packaging films. Due at least partially to high technical and quality demands for raw materials used in oriented films, use of recycled polypropylene, such as polypropylene post-consumer (“PP-PCR”) and/or polypropylene post-industry (“PP-PIR”) was difficult and modest, at best. Many plastics often impact the environment in detrimental ways, including, for instance, trash production and increased emissions of carbon dioxide during processing. As a result, it is a great challenge to re-think the re-use of plastics to reduce the environmental impact of the waste residues resulting from the use of polypropylene in many applications. In the ensuing pages, disclosed are example embodiments of BOPP films and labels comprising PP-PIR with selected quality properties for various applications, e.g., packaging, tape films, in-mold labeling, pressure-sensitive labeling, wrap-around labeling that at least mitigate optical defects, process stability, and/or other issues in the art.

PP-PIR resins are available in the market, but because of high heterogeneity among sources, as well as the chemical and mechanical damage that the plastic suffers in its entire chain, i.e., from production to converting, the properties of those PP-PIR resins are generally poor, and, thus, a challenge to reuse them in many applications, which require high property standards.

Polymer-based plastics may be used today to manufacture a varied range of articles, including films, molded products, foams, bottles, bags, tissues, and more with particular characteristics. In relation to polypropylene, downgrading of the end-of-use scraps is possible for low-quality products having unpredictable properties.

Virgin polypropylene has many beneficial values in production and manufacture of polypropylene films. But, plastics often impact the environment in detrimental ways including trash production and increased emission of CO₂ during processing. So it is a great challenge for producers and end users to think about the use and re-use of plastics to reduce the environmental impact of the waste residues.

### SUMMARY

In one example embodiment is an oriented film comprising at least one layer comprising ≥about 5 wt. % through≤about 95 wt. % of a combination of virgin polypropylene and post-industrial reclaimed polypropylene, and has a melt flow index from about 0.5 g/min through about 15 g/min and a dispersion index from about 2 through 10. Further, the filter pressure of the oriented film's post-industrial reclaimed polypropylene≤about 20 bar/kg when using a 350-mesh filter on a COLLIN Teach Line Type FT-E20T extruder according to the method and settings in this description as such films are commercially stable, including those having≤about 30 bar/kg or even≤about 50 bar/kg that may be made and used according to the methods, films, and labels within and supported by this disclosure. Further still in one example embodiment, the oriented film is neither cavitated nor pigmented, and the oriented film has a haze of about 50% or less. The total thickness of the disclosed films may be≤about 15 μm, ≤about 20 μm, ≤about 25 μm, ≤ about 50 μm, or even≤about 100 μm in various embodiments. The post-industrial reclaimed polypropylene used in the oriented film may or may not be fully or partially from coated-PP-PIR scraps of films, films, etc., such as those discussed later in this disclosure.

### DETAILED DESCRIPTION

Below, directional terms, such as “above,” “below,” “upper,” “lower,” “front,” “back,” “top,” “bottom,” etc., are used for convenience in referring to the accompanying drawings. In general, “above,” “upper,” “upward,” “top,” and similar terms refer to a direction away the earth's surface, and “below,” “lower,” “downward,” “bottom,” and similar terms refer to a direction toward the earth's surface, but is meant for illustrative purposes only, and the terms are not meant to limit the disclosure.

Various specific embodiments, versions and examples are described now, including exemplary embodiments and definitions that are adopted herein for purposes of understanding. While the following detailed description gives specific preferred embodiments, those skilled in the art will appreciate that these embodiments are exemplary only, and that the disclosure can be practiced in other ways. For purposes of determining infringement, the scope of the invention will refer to the any claims, including their equivalents, and elements or limitations that are equivalent to those that are recited.

As used herein, “polymer” may be used to refer to homopolymers, copolymers, interpolymers, terpolymers, etc. Likewise, a “copolymer” may refer to a polymer comprising two monomers or to a polymer comprising three or more monomers.

As used herein, “elastomer” is defined as a propylene-based or ethylene-based copolymer that can be extended or stretched with force to at least 100% of its original length, and upon removal of the force, rapidly (e.g., within 5 seconds) returns to its original dimensions.

As used herein, “plastomer” is defined as a propylene-based or ethylene-based copolymer having a density in the range of 0.850 g/cm³ to 0.920 g/cm³ and a DSC melting point of at least 40° C.

As used herein, “intermediate” is defined as the position of one layer of a multilayered film, wherein said layer lies between two other identified layers. In some embodiments, the intermediate layer may be in direct contact with either or both of the two identified layers. And/or in other embodiments, additional layers may also be present between the intermediate layer and either or both of the two identified layers.

As used herein, “substantially free” is defined to mean that the referenced film layer is largely, but not wholly, absent a particular component. In some embodiments, small amounts of the component may be present within the referenced layer as a result of standard manufacturing methods, including recycling of film scraps and edge trim during processing.

By “consist essentially of,” what is meant, for example, is that a particular film layer does not have any more than 1 wt. % or 2 wt. % or 3 wt. % or 4 wt. % or 5 wt. % of other polymers in the bulk material constituting the film layer's composition, but “consist essentially of” does not exclude the possibility that the particular film layer also has additives, such as anti-slip agents, anti-blocking agents, anti-oxidants, pigments, whitening agents, cavitation agents, etc. regardless of what polymers or other materials make up the additive(s).

As used herein, “about” means the number itself and/or within 5% of the stated number. For instance, with about 5%, this means 5 and/or any number or range within the range of 4.75 to 5.25, e.g., 4.75 to 4.96, 4.81 to 5.1, etc.

PP-PIR is made from polypropylene generated as waste in the converting industry of the PP (e.g., BOPP) film and/or labels. These converters, for example, include coating, printing and/or packaging facilities. Their scrap products have not been used finally by the end consumer, and, thus, are not PP-PCR. The scraps, for example, might result from cutting edges, portions of transition reels, or off-grade produced in the converting step of the packaging film. These scraps might be recycled directly and reclaimed on a common recycling unit, or they can be cleaned in a separate washing step to remove the coatings, inks, or other contaminations, and after a drying step, be reclaimed.

It is also possible to re-use the PIR film scraps by grinding, agglomerating, and then heating up the film in a plast-agglomerator device slightly below the melting point, which increases the bulk density by clotting the flakes together, and thereby subjecting the scrap to minimal and insignificant lower thermal stress.

Internal reclaim (“IR”) is recycled polypropylene scrap resulting during the production of the BOPP film, itself, and accumulating in the production facility in place before leaving the production site for further converting steps. Accordingly, use of “reclaimed PP” in this disclosure should be understood to be PP-PIR, whether alone or in combination with any other type of reclaim, including IR, for optionally mixing with virgin reclaim and/or non-recycled polymers, including PP, whether homopolymers, copolymers and/or terpolymers of any type.

Turning towards an overview of the disclosed films and labels before turning further to details, a filter pressure test involving filter mesh and pressure increase was used to evidence that films and labels, whether biaxially or monoaxially oriented, could contain reclaimed PP that resulted in “stable productions” as defined herein. Surprisingly, reclaimed-PP-containing films showed a filter pressure increase at a mesh above the film's final film thickness may be used. In various embodiments, the reclaimed-PP-containing films and labels may be mono- or co-extrusion two-, three-, four-, five-layered, or more. And, the reclaimed-PP-containing films and labels may have the reclaimed-PP in the core layer and/or one or more tie layers. Filter pressure values≥50 bar/kg produce films with more film breaks, quality issues, and are generally commercially unacceptable films, and this is why this disclosure teaches use of 50 bar/kg or below as its surprisingly possible to make upgraded products therefrom instead of relegating use into a downgraded product or not used at all, i.e., garbage. As a result, this invention solves a problem by improving the lifecycle (i.e., birth to bin) of PP-PIR film.

In various example embodiments, disclosed are reclaimed-PP-containing methods, films, and labels having at least one layer comprising, consisting essentially of, or consisting of a PP-PIR polymer composition or combination thereof, wherein its reclaimed-PP content may vary from greater than or equal to about 5 wt. % through greater than or equal to about 95 wt. %-and any range in between that minimum and maximum without reciting each and every possible range, e.g., about 6 wt. % to about 12 wt. %, about 23 wt. % through about 67 wt. %, etc.—in combination with: (1) a virgin-PP-containing polymer resin content varying from greater than or equal to about 5 wt. % through greater than or equal to about 95 wt. %- and any range in between that minimum and maximum without reciting each and every possible range; and (2) optionally, additives, such as those named later in this disclosure. The virgin PP-containing polymer may be selected from PP homopolymers (e.g., iPP, sPP, etc.), PP copolymers, and combinations thereof. The reclaimed-PP-containing films and labels resulted in stable productions, wherein a “stable production” means no web breaks on a BOPP tenter manufacturing tenter line run anywhere from 50 through 600 m/min at a temperature from 80 through 180° C., with a web width anywhere between 1.5 through 10 m, over a time period of about 1.5 h. In some embodiments, this may result in the disclosed films having a filter pressure of ≤30 bar/kg, in other embodiments≤40 bar/kg, in other embodiments, and ≤50 bar/kg.

A COLLIN Teach Line Type FT-E20T extruder was used in measuring filter pressure increase of the reclaimed PP-PIR grades. Granular reclaimed-PP was melted in the extruder, homogenized, and conveyed. The gear pump conveyed the melt at a constant throughput through a sieve, having different mesh sizes, and filter. The contaminants in the reclaimed-PP that are larger than the meshes of the sieve are retained, and, thereby, create an increase in pressure before the filter. The pressure curve from the beginning to the end of the filter test is recorded by means of the evaluation software and the pressure increase is recorded over time. The pressure increase is directly related to the number and size of the retained contaminants in the reclaimed-PP, i.e., contamination/particle size distribution. To state the foregoing discussion by a formula:

$$Teach Line Type FT - E 20 T FPI = ( P max - Ps ) / W$$

$$FPI = Filter pressure increase [ stated in bar / kg ]$$

$$Ps = Initial pressure at the beginning of the experiment$$

$$P max = maximum pressure detected after extrusion of one Kg PIR through the filter$$

$$W = Weight of extruded polymer$$

The settings used for the COLLIN Teach Line Type FT-E20T extruder were:
Speed Gearpump: 50 Upm
Extruder speed: 50 Upm
Extruder temperature: Zone 1:200° C., Zone 2-6:230° C.
Filter size (flow through area): 615 mm²

As filters, four different metal wire mesh filter discs, available from HAVER & BOECKER OHG, 59302 Oelde Germany, are used with 100 mesh up to 500 mesh.

Below are more examples of reclaimed-PP-containing films and labels. In Table 1, presented are tested reclaimed-PP films and their filter pressure values, wherein the last three columns are in bold font to show that these films were stable productions. The melt flow indices (ASTM D1238, 230° C., 2.16 kg) of the sources in the last five columns may be from 0.5 through 15 g/10 min, and their dispersion indices, which equals <Mw>/<Mn>, may be from 2 through 10.

TABLE 1

| | | | | | | | | N6 | | | |
|---|---|---|---|---|---|---|---|---|---|---|---|
| | | | | | | N4 | N5 | Reclaim | N7 | | |
| | | | | | | Reclaim | Reclaim | resulting | Reclaim | | N9 |
| | | | Ref. N1 | | | transparent | resulting | from | from | N8 | Reclaim |
| | | | Internal | N2 | | BOPP film | from | acrylic-, | coated | Reclaim, | blend |
| | | | Reclaim | Ravago | N3 | coated with | acrylic | EVOH and | scraps | selected | (18XB801, |
| | | | used in | Mafill/ | Total | Acrylic | coated | PU coated | after | only | 16MB890, |
| Reclaim Number | | | BOPP | 300 μm | rPPH03GR | and PU | MB666 | film scraps | washing | 30MB666 | 16AO804) |
| Filter | μm | Mesh | Filter Pressure (bar/kg) | | | | | | | | |
| Type | | | | | | | | | | | |
| fSPW | ~150 | 100 | — | 0.3 | 2.4 | — | — | — | — | — | — |
| 250 | | | | | | | | | | | |
| SPW | ~75 | 200 | — | 1.5 | 60.8 | 1 | | — | — | — | 1 |
| 125 | | | | | | | | | | | |
| SPW | ~40 | 350 | — | 22.7 | 137 | 7 | 1 | 0.5 | 2.4 | — | 13 |
| 63 | | | | | | | | | | | |
| DTW | ~30 | 500 | 0.5 | 163 | 1550 | 16.0 | 6.8 | 3.8 | 8.9 | 2.0 | 34.0 |
| 45 S | | | | | | | | | | | |

Reclaim Ref. (i.e., reference or also known as N1) is internal reclaim made from transparent film scraps selected inside the BOPP manufacturing site, and is today used in standard BOPP-film production.

Reclaim Number 2 is a commercially available polypropylene-based PIR supplied by Ravago. Mafill™ PP grades are recycled materials selected from post-industrial materials recommended for a wide variety of applications like automotive and industrial parts.

Reclaim Number 3 is a commercially available post-consumer reclaim supplied by company TOTAL for various applications.

Reclaim Number 4 is a PIR produced from film scraps of various coated transparent films resulting from edges transition reels and fluff from film scraps selected after the coating process. The scraps are a mix of films which are polyurethane- and acrylic-coated.

Reclaim Number 5 is a PIR produced from film scraps selected from only acrylic coated transparent films resulting from edges transition reels and fluff from film scraps selected after the coating process.

Reclaim Number 6 is a PIR produced from film scraps of various coated transparent films resulting from edges transition reels and fluff from film scraps selected after the coating process. The scraps are a mix of films which are polyurethane—(e.g., Jindal Films™ 50LL347), acrylic—(e.g., Jindal Films™ 35MB666) or EVOH coated (e.g., Jindal Films™ 18MB890).

Reclaim Number 7 is a PIR produced from film scraps of various coated transparent films washed at 60° C. in a 1 m caustic solution for 1 h to remove the coating. After a second washing step with clean water, the scraps were diced and put in an agglomeration system. The scraps are a mix of films which are polyurethane-, acrylic- and/or EVOH-coated.

Reclaim Number 8 is a PIR produced from film scraps selected from acrylic-coated transparent films with only one thickness of 30 μm resulting only from the edges resulting from the slitting process of the coated films.

Reclaim Number 9 is a PIR produced from mixed film scraps selected from transparent film scraps as they are EVOH-coated (e.g., Jindal Films™ 16MB890), PVD coated AlOx layer (e.g., Jindal Films™ 16AO804) and EVOH coextruded film scrap (e.g., Jindal Films™ 18XB801).

Turning now to film example embodiments, below are exemplary transparent BOPP films in accordance with this disclosure produced on a BOPP pilot line using the different PP-PIR grades. Reference 1 is a standard BOPP three-layer coextruded film, which one in application may be used packaging or tape application. Reference 1 does not contain any reclaimed PP. The table immediately below provides more details about Reference 1. The homopolypropylene (hPP) used in all examples of this disclosure was Moplen HP525J (LyondelBasell MFI=3.0, Filter Pressure DTW 45S<0.1 bar/kg). However, in other embodiments, different PPs than found in any of the examples' layers below, including other hPPs and/or iPP, sPP, PP, PP copolymers, or combinations thereof, may be used as a replacement to the hPP in the examples without departing from the invention so long as these PP polymers abide by the melt and polyolefin dispersity indices mentioned in the preceding paragraph so as to result in stable productions according to the disclosed methods and settings in this disclosure.

Table 2 shows the results achieved producing a standard 25 μm BOPP film standard BOPP film containing PIR in different concentrations in the base layer.

TABLE 2

| | | | | E- | E- | Tensile | Tensile | | Gloss @ | |
|---|---|---|---|---|---|---|---|---|---|---|
| | PP-Reclaim | X | Film | modulus | modulus | strength | strength | Haze | 45° | |
| | Number from | % | Thick- | MD | TD | MD | MD | ASTM D | ASTM D | Stable |
| Example | Table 1 | PIR | ness/μm | N/mm² | N/mm² | N/mm² | N/mm² | 1003 | 2457 | production |
| Reference 1 | — | — | 25 | 2030 | 4679 | 144 | 323 | 3 | 90 | Yes |
| Example 1 | N5 | 50 | 25 | 2038 | 3895 | 143 | 254 | 19 | 121 | Yes |
| Example 2 | N5 | 60 | 25 | 1894 | 3969 | 134 | 237 | 35 | 126 | Yes |
| Example 3 | N5 | 80 | 25 | 1838 | 3824 | 129 | 231 | 39 | 130 | Yes |
| Example 4 | N5 | 100 | 25 | 1847 | 3700 | 117 | 235 | 44 | 128 | Yes |
| Counter- | N2 | 50 | 25 | 1623 | 3210 | 111 | 213 | 68 | 95 | No |
| Example 1 | | | | | | | | | | |
| Counter- | N3 | 50 | 25 | 1412 | 2918 | 98 | 118 | 77 | 87 | No |
| Example 2 | | | | | | | | | | |

In these and other oriented films produced but not particularly disclosed in the tables, the oriented films having at least one layer comprising ≥about 5 wt. % through≤about 95 wt. % of a combination of virgin polypropylene as well as the post-industrial reclaimed polypropylene having a melt flow index from about 0.5 g/min through about 15 g/min and a dispersion index from about 2 through 10, wherein the filter pressure of the post-industrial reclaimed polypropylene≤about 20 bar/kg when using a 350-mesh filter on a COLLIN Teach Line Type FT-E20T extruder according to the method and settings disclosed herein, the disclosed oriented films and those not particularly disclosed herein all had a haze of about 50% or less (e.g., about 45% or less, about 40% or less, about 35% or less, about 30% or less, about 25% or less, about 20% or less, or about 15% or less in alternative embodiments) under ASTM D 1003, and also were neither cavitated nor pigmented,
Reference 1 from Table 2

Reference 1 is the formulation of a 25 μm standard BOPP film, which might be used in applications as packaging or tape films. The core and/or tie layers comprise, consist essentially of, or consists of polypropylene homopolymer suitable for the BOPP stretching process and optionally one or more additives (antioxidants, stabilizers, antistatic, and/or slip additives without limitation, i.e., any combination of these and/or other additives may be present in any layer of any film or label produced). Each of the skins comprises, consist essentially of or consists of any copolymer or terpolymer comprising carbons from C1-C8, optionally in combination with one or more additives, including an antiblock, e.g., ABPP 05 SC (or other PMMA or other antiblock particles based on silica, PMMA-, epoxy, silicone, etc.) in at least one of the skin layers.

| | | corona-treated (optional) |
|---|---|---|
| Coex # 1 | 1 μm | 100% std terpo KS385 (skin layer) |
| Coex # 3 | 3.2 μm | 100% PP hPP (tie layer) |
| Main core | 19 μm | 100% PP hPP (base or core layer) |
| Coex # 4 | 2 μm | 100% PP hPP (tie layer) |
| Coex # 2 | 1 μm | 100% std terpo KS385 (skin layer) |
| | thickness | corona-treated (optional) |

Examples 1˜4 from Table 2

The Examples 1˜4 are the formulations based on Reference 1, and increasing the amount of PIR N5, the PIR produced from film scraps selected from only acrylic coated transparent films resulting from edges transition reels and fluff from film scraps selected after the coating process. The PIR in the base layer may be increased starting at X=50% and may be successively increased to X=60%, X=80%, and X=100%, all of which resulted in stable film productions.

| | | corona-treated (optional) |
|---|---|---|
| Coex # 1 | 1 μm | 100% std terpo KS385 (skin layer) |
| Coex # 3 | 3.2 μm | 100% PP hPP (tie layer) |
| Main core | 19 μm | (100-X) % hPP + X % PIR (base or core layer) |
| Coex # 4 | 2 μm | 100% PP hPP (tie layer) |
| Coex # 2 | 1 μm | 100% std terpo KS385 (skin layer) |
| | thickness | corona-treated (optional) |

If PP-PIR N5 as mentioned in Table 2 is used, the production line shows stable production, i.e., filter pressure is at or below 20. And the concentration of PIR can be increased up to 100% in the base layer without affecting a stable production of the 25 μm BOPP film. If the PP-PIRs N2 is used, a stable production does not occur even adding only 50% in the base layer. Also using the PCR Total N3, no film production at all is possible.

Table 3 shows the results achieved producing a standard 25 μm BOPP film standard BOPP film, adding different types of PIR in addition to 30% internal reclaim to the core layer.

TABLE 3

| | | | | E- | E- | Tensile | Tensile | | Gloss @ | |
|---|---|---|---|---|---|---|---|---|---|---|
| | | | Film | modulus | modulus | strength | strength | Haze | 45° | |
| | | % | Thick- | MD | TD | MD | MD | ASTM D | ASTM D | Stable |
| Example | PIR | PIR | ness μm | N/mm² | N/mm² | N/mm² | N/mm² | 1003 | 2457 | production |
| Reference 2 | N1 PP IR | 30 | 25 | 2030 | 4598 | 146 | 313 | 3 | 93 | Yes |
| Example 5 | N4 + N1 | 50 | 25 | 2011 | 3798 | 141 | 267 | 20 | 117 | Yes |
| Example 6 | N6 + N1 | 60 | 25 | 2021 | 3789 | 139 | 248 | 21 | 112 | Yes |
| Example 7 | N7 + N1 | 70 | 25 | 2034 | 3879 | 138 | 237 | 22 | 109 | Yes |
| Example 8 | N8 + N1 | 50 | 25 | 2027 | 4269 | 140 | 298 | 9 | 112 | Yes |
| Example 9 | N9 + N1 | 50 | 25 | 1989 | 3432 | 127 | 213 | 17 | 113 | Yes |
| Counter- | N2 + N1 | 30 | 25 | 1623 | 3210 | 111 | 213 | 68 | 95 | No |
| Example 3 | | | | | | | | | | |
| Counter- | N3 + N1 | 30 | 25 | 1412 | 2918 | 98 | 118 | 77 | 87 | No |
| Example 4 | | | | | | | | | | |

Reference 2 from Table 3

The formulation of Reference 2 is similar to Reference 1, a standard BOPP film, which in one application may be used in a packaging or tape application. Compared to Reference 1, however, Reference 2 contains in the base layer additional internal reclaim resulting from the internal recycling of transparent BOPP-film production.

| | | corona-treated (optional) |
|---|---|---|
| Coex # 1 | 1 μm | 100% std terpo KS385 (skin layer) |
| Coex # 3 | 3.2 μm | 100% PP hPP (tie layer) |
| Main core | 19 μm | 70% PP hPP + 30% PP-internal reclaim |
| | | (base or core layer) |
| Coex # 4 | 2 μm | 100% PP hPP (tie layer) |
| Coex # 2 | 1 μm | 100% std terpo KS385 (skin layer) |
| | thickness | corona-treated (optional) |

Examples 5-9 from Table 3

Examples 5-9 are formulations based on Reference 2 that have different types of PIR, i.e., N4-N9, at a concentration of X % PIR in the base layer. Similar to Reference 2, the film in Examples 5-9 contain 30% of transparent internal reclaim in the base layer.

| | | corona-treated (optional) |
|---|---|---|
| Coex # 1 | 1 μm | 100% std terpo KS385 (skin layer) |
| Coex # 3 | 3.2 μm | 100% PP hPP (tie layer) |
| Main core | 19 μm | (70-X) % hPP + 30% PP-internal |
| | | reclaim + X % PIR (base or core layer) |
| Coex # 4 | 2 μm | 100% PP hPP (tie layer) |
| Coex # 2 | 1 μm | corona-treated (optional) |
| | thickness | corona-treated (optional) |

Table 4 shows the results achieved by producing a 48 μm BOPP for use, for example in label or film applications, having the addition of different types of PIR with varying concentrations.

TABLE 4

| | | | | E- | E- | Tensile | Tensile | | Gloss @ | |
|---|---|---|---|---|---|---|---|---|---|---|
| | | | Film | modulus | modulus | strength | strength | Haze | 45° | |
| | | % | Thick- | MD | TD | MD | MD | ASTM D | ASTM D | Stable |
| Example 3 | PIR | PIR | ness | N/mm² | N/mm² | N/mm² | N/mm² | 1003 | 2457 | production |
| Reference 3 | N1 | 20 | 48 | 1991 | 4776 | 141 | 301 | 1.7 | 122 | Yes |
| Example 10 | N5 + N1 | 50 | 48 | 2017 | 3769 | 147 | 289 | 23 | 123 | Yes |
| Example 11 | N7 + N1 | 50 | 48 | 2007 | 3675 | 149 | 297 | 7 | 121 | Yes |
| Example 12 | N9 + N1 | 50 | 48 | 2023 | 3765 | 142 | 263 | 14 | 112 | Yes |
| Example 13 | N7 + N1 | 80 | 48 | 1997 | 3632 | 142 | 291 | 9 | 109 | Yes |
| Example 14 | N9 + N1 | 80 | 48 | 1938 | 3679 | 137 | 236 | 16 | 112 | Yes |
| Example 15 | N9 + N1 | 90 | 48 | 1922 | 3657 | 133 | 227 | 17 | 113 | Yes |
| Counter- | N2 + N1 | 30 | 48 | 1623 | 3210 | 111 | 213 | 68 | 95 | No |
| Example 5 | | | | | | | | | | |
| Counter- | N3 + N1 | 30 | 48 | 1412 | 2918 | 98 | 118 | 77 | 87 | No |
| Example 6 | | | | | | | | | | |

Reference 3 from Table 4

The formulation of Reference 3 demonstrates the production of BOPP “thick” films, i.e., greater than about a standard 25 μm, film, that may be used in labeling applications as they are wrap-around labels, pressure sensitive labels, or in-mold labels. Other films disclosed herein, even if thinner, may be used in label applications too. Other applications for these films are strong tapes or packaging films for large pouches. Core and/or tie layers comprise, consists essentially of, or consists of polypropylene homopolymer suitable for the BOPP stretching process and contain optionally one or more additives (e.g., antioxidants, stabilizers, antistatic, and/or slip additives without limitation). One or each of the skins comprises, consist essentially of or consists of any copolymer or terpolymer comprising carbons from C1-C8, optionally in combination with one or more additives, including an antiblock, e.g., ABPP 05 SC (or other PMMA or other antiblock particles based on silica, PMMA-epoxy, silicone, etc.) in at least one of the skin layers. A general structure of Reference 3 is the schematic immediately below.

| | | flame-treated (optional) |
|---|---|---|
| Coex # 1 | 1 μm | 100% Basell Adsyl 5C39F (skin layer) |
| Coex # 3 | 4 μm | 100% PP hPP (tie layer) |
| Main core | 38 μm | 80% hPP + 20% PP-internal reclaim |
| | | (base or core layer) |
| Coex # 4 | 4 μm | 100% PP hPP (tie layer) |
| Coex # 2 | 1 μm | 100% Basell Adsyl 5C39F (skin layer) |
| | thickness | flame-treated (optional) |

Examples 10-15 from Table 4

Table 4 shows formulations based on Reference 3 that have varying concentrations and different types of PIR, e.g., N5, N7, and N9. The concentration of the PIRs is increased from 50% in the base layer up to 90% in the base layer. Similar to Reference 3, these films contain 20% PP-internal reclaim.

| | | flame-treated (optional) |
|---|---|---|
| Coex # 1 | 1 μm | 100% Basell Adsyl 5C39F (skin layer) |
| Coex # 3 | 4 μm | 100% PP hPP (tie layer) |
| Main core | 38 μm | (80-X) % hPP + X % PIR + 20% PP-internal |
| | | reclaim (base or core layer) |
| Coex # 4 | 4 μm | 100% PP hPP (tie layer) |
| Coex # 2 | 1 μm | 100% Basell Adsyl 5C39F (skin layer) |
| | thickness | flame-treated (optional) |

In all cases, the production line shows stable production for the above-mentioned PIRs. If the N2 and N3 are used, a stable production does not occur even adding in addition to the internal reclaim only 30% in the base layer.

In other example embodiments, 2-layered, 3-layered, or 4-layered films may be produced that do not depart from the scope of the disclosed invention. In these other example embodiments, 2-layered example embodiments comprise, consists essentially of, or consists of a disclosed skin and core layer. The 3-layered example embodiments comprise, consists essentially of, or consists of a disclosed skin layer, tie layer, and core layer. The 4-layered example embodiments comprise, consists essentially of, or consists of a disclosed skin layer, tie layers, and core layer. In any example embodiment, the tie layers may be the same or different in composition, thickness, or both. Furthermore, the composition of a tie layer in any embodiment of the disclosed films (i.e., inclusive of labels) produced follows the formula of (hPP+PIR+PP-internal reclaim), wherein each of these three components may be any value from 0 through 100 wt. % whether alone or in combination with any additives. And, the composition of the core layer and skin layer(s) in any embodiment of the disclosed films may include or exclude any additives.

### Polypropylene

The polypropylene (“PP”) that is preferably used in the core layer is a homopolymer or copolymer comprising from 60 wt. % or 70 wt. % or 80 wt. % or 85 wt. % or 90 wt. % or 95 wt. % or 98 wt. % or 99 wt. % to 100 wt. % propylene-derived units (and comprising within the range of from 0 wt. % or 1 wt. % or 5 wt. % to 10 wt. % or 15 wt. % or 20 wt. % or 30 wt. % or 40 wt. % C2 and/or C₄ to C₁₀ α-olefin derived units) and can be made by any desirable process using any desirable catalyst as is known in the art, such as a Ziegler-Natta catalyst, a metallocene catalyst, or other single-site catalyst, using solution, slurry, high pressure, or gas phase processes. Polypropylene copolymers are useful polymers in certain embodiments, especially copolymers of propylene with ethylene and/or butene, and comprise propylene-derived units within the range of from 70 wt. % or 80 wt. % to 95 wt. % or 98 wt. % by weight of the polypropylene. In any case, useful polypropylenes have a melting point (ASTM D3418) of at least 125° C. or 130° C. or 140° C. or 150° C. or 160° C., or within a range of from 125° C. or 130° C. to 140° C. or 150° C. or 160° C. A “highly crystalline” polypropylene is useful in certain embodiments, and is typically isotactic and comprises 100 wt. % propylene-derived units (propylene homopolymer) and has a relatively high melting point of from greater than (greater than or equal to) 140° C. or 145° C. or 150° C. or 155° C. or 160° C. or 165° C.

The term “crystalline,” as used herein, characterizes those polymers which possess high degrees of inter- and intra-molecular order. Preferably, the polypropylene has a heat of fusion (Hf) greater than 60 J/g or 70 J/g or 80 J/g, as determined by DSC analysis. The heat of fusion is dependent on the composition of the polypropylene; the thermal energy for the highest order of polypropylene is estimated at 189 J/g that is, 100% crystallinity is equal to a heat of fusion of 189 J/g A polypropylene homopolymer will have a higher heat of fusion than a copolymer or blend of homopolymer and copolymer. Also, the polypropylenes useful herein may have a glass transition temperature (ISO 11357-1, Tg) preferably between −20° C. or −10° C. or 0° C. to 10° C. or 20° C. or 40° C. or 50° C. Preferably, the polypropylenes have a Vicat softening temperature (ISO 306, or ASTM D 1525) of greater than 120° C. or 110° C. or 105° C. or 100° C., or within a range of from 100° C. or 105° C. to 110° C. or 120° C. or 140° C. or 150° C., or a particular range of from 110° C. or 120° C. to 150° C.

Preferably, the polypropylene has a melt flow rate (“MFR” or melt flow index “MFI”, 230° C., 2.16 kg, ASTM D1238) within the range of from 0.1 g/10 min or 0.5 g/10 min or 1 g/10 min to 4 g/10 min or 6 g/10 min or 8 g/10 min or 10 g/10 min or 12 g/10 min or 16 g/10 min or 20 g/10 min. Also, the polypropylene may have a molecular weight distribution (determined by GPC) of from 1.5 or 2.0 or 2.5 to 3.0 or 3.5 or 4.0 or 5.0 or 6.0 or 8.0, in certain embodiments. Suitable grades of polypropylene that are useful in the oriented films described herein include those made by ExxonMobil, LyondellBasell, Total, Borealis, Japan Polypropylene, Mitsui, and other sources.

### Skin Layer(s), Including Metallizable Skin Layers and Printable Layers

In some embodiments, the skin layer comprises at least one polymer selected from the group comprising, consisting essentially of, and/or consisting of polypropylene copolymers or terpolymers (e.g., EPB shown in the tables), which may be grafted or copolymerized, and a metallocene based material of either polypropylene or ethylene propylene copolymer.

The skin layer may also comprise processing aid additives, such as anti-block agents, anti-static agents, slip agents and combinations thereof, as discussed in further detail below.

The thickness of the skin layer depends upon the intended function of the skin layer, but is typically in the range of from about 0.20 μm through 3.5 μm, or from 0.30 μm through 2 μm, or in many embodiments, from 0.50 μm through 1.0 μm. In thin film embodiments, the skin layer thickness may range from about 0.20 μm through 1.5 μm, or 0.50 μm through 1.0 μm.

### Additives

Additives present in the film's layer(s) may include, but are not limited to opacifying agents, pigments, colorants, cavitating agents, slip agents, antioxidants, anti-fog agents, anti-static agents, anti-block agents, fillers, moisture barrier additives, gas barrier additives, gas scavengers, and combinations thereof. Such additives may be used in effective amounts, which vary depending upon the property required.

Examples of suitable opacifying agents, pigments or colorants are iron oxide, carbon black, aluminum, titanium dioxide (TiO₂), calcium carbonate (CaCO₃), and combinations thereof.

Cavitating or void-initiating additives may include any suitable organic or inorganic material that is incompatible with the polymer material(s) of the layer(s) to which it is added, at the temperature of biaxial orientation, in order to create an opaque film. Examples of suitable void-initiating particles are PBT, nylon, solid or hollow pre-formed glass spheres, metal beads or spheres, ceramic spheres, calcium carbonate, talc, chalk, or combinations thereof. The average diameter of the void-initiating particles typically may be from about 0.1 to 10 μm.

Slip agents may include higher aliphatic acid amides, higher aliphatic acid esters, waxes, silicone oils, and metal soaps. Such slip agents may be used in amounts ranging from 0.1 wt % to 2 wt % based on the total weight of the layer to which it is added. An example of a slip additive that may be useful is erucamide.

Non-migratory slip agents, used in one or more skin layers of the multilayered films, may include polymethyl methacrylate (PMMA). The non-migratory slip agent may have a mean particle size in the range of from about 0.5 μm to 8 μm, or 1 μm to 5 μm, or 2 μm to 4 μm, depending upon layer thickness and desired slip properties. Alternatively, the size of the particles in the non-migratory slip agent, such as PMMA, may be greater than 20% of the thickness of the skin layer containing the slip agent, or greater than 40% of the thickness of the skin layer, or greater than 50% of the thickness of the skin layer. The size of the particles of such non-migratory slip agent may also be at least 10% greater than the thickness of the skin layer, or at least 20% greater than the thickness of the skin layer, or at least 40% greater than the thickness of the skin layer. Generally spherical, particulate non-migratory slip agents are contemplated, including PMMA resins, such as EPOSTAR™ (commercially available from Nippon Shokubai Co., Ltd. of Japan). Other commercial sources of suitable materials are also known to exist. Non-migratory means that these particulates do not generally change location throughout the layers of the film in the manner of the migratory slip agents. A conventional polydialkyl siloxane, such as silicone oil or gum additive having a viscosity of 10,000 to 2,000,000 centistokes is also contemplated.

Suitable anti-oxidants may include phenolic anti-oxidants, such as IRGANOX® 1010 (commercially available from Ciba-Geigy Company of Switzerland). Such an anti-oxidant is generally used in amounts ranging from 0.1 wt % to 2 wt %, based on the total weight of the layer(s) to which it is added.

Anti-static agents may include alkali metal sulfonates, polyether-modified polydiorganosiloxanes, polyalkylphenylsiloxanes, and tertiary amines. Such anti-static agents may be used in amounts ranging from about 0.05 wt % to 3 wt %, based upon the total weight of the layer(s).

Examples of suitable anti-blocking agents may include silica-based products such as SYLOBLOC® 44 (commercially available from Grace Davison Products of Colombia, Md.), PMMA particles such as EPOSTAR™ (commercially available from Nippon Shokubai Co., Ltd. of Japan), or polysiloxanes such as TOSPEARL™ (commercially available from GE Bayer Silicones of Wilton, Conn.). Such an anti-blocking agent comprises an effective amount up to about 3000 ppm of the weight of the layer(s) to which it is added.

Useful fillers may include finely divided inorganic solid materials such as silica, fumed silica, diatomaceous earth, calcium carbonate, calcium silicate, aluminum silicate, kaolin, talc, bentonite, clay and pulp.

Optionally, nonionic or anionic wax emulsions can be included in the coating(s), i.e., skin layer(s), to improve blocking resistance and/or lower the coefficient of friction. For example, an emulsion of Michem Lube 215, Michem Lube 160 may be included in the skin layer(s). Any conventional wax, such as, but not limited to Carnauba™ wax (commercially available from Michelman Corporation of Cincinnati, Ohio) that is useful in thermoplastic films is contemplated.

### Metallization

The outer surface (i.e., side facing away from the core) of a skin layer and/or laminating substrate may undergo metallization after optionally being treated. Metallization may be carried out through conventional methods, such as vacuum metallization by deposition of a metal layer such as aluminum, copper, silver, chromium, or mixtures thereof. Following metallization, a coating may be applied to the outer metallized layer “outside” or “inside” the vacuum chamber to result in the following structure: metallized layer/skin layer/optional tie layer/core/optional tie layer/skin layer/metallized layer. In an additional embodiment, a primer may be applied on the metal surface(s) followed by top coating(s).

In certain embodiments, the metal for metallization is metal oxide, any other inorganic materials, or organically modified inorganic materials, which are capable of being vacuum deposited, electroplated or sputtered, such as, for example, SiOx, AlOx, SnOx, ZnOx, IrOx, wherein x=1 or 2, organically modified ceramics “ormocer”, etc. The thickness of the deposited layer(s) is typically in the range from 100 to 5,000 Angstrom or preferably from 300 to 3000 Angstrom.

### Surface Treatment

One or both of the outer surfaces of the multilayered films may be surface-treated to increase the surface energy to render the film receptive to metallization, coatings, printing inks, adhesives, and/or lamination. The surface treatment can be carried out according to one of the methods known in the art including corona discharge, flame, plasma, chemical treatment, or treatment by means of a polarized flame.

### Priming

An intermediate primer coating may be applied to multilayered films. In this case, the film may be first treated by one of the foregoing methods to provide increased active adhesive sites thereon and to the thus-treated film surface there may be subsequently applied a continuous coating of a primer material. Such primer materials include, for example, epoxy, poly(ethylene imine) (PEI), and polyurethane materials. U.S. Pat. Nos. 3,753,769, 4,058,645 and 4,439,493, each incorporated herein by reference, discloses the use and application of such primers. The primer provides an overall adhesively active surface for thorough and secure bonding with the subsequently applied coating composition and can be applied to the film by conventional solution coating means, for example, by roller application.

### Orienting

The films herein are also characterized in certain embodiments as being biaxially oriented. The films can be made by any suitable technique known in the art, such as a tentered or blown process, LISIM™, and others. Further, the working conditions, temperature settings, lines speeds, etc. will vary depending on the type and the size of the equipment used. Nonetheless, described generally here is one method of making the films described throughout this specification. In a particular embodiment, the films are formed and biaxially oriented using the tentered method. In the tentered process, line speeds of greater than 100 m/min to 400 m/min or more, and outputs of greater than 2000 kg/h to 4000 kg/h or more are achievable. In the tenter process, sheets/films of the various materials are melt-blended and coextruded, such as through a 3, 4, 5, 7-layer die head, into the desired film structure. Extruders ranging in diameters from 100 mm to 300 or 400 mm, and length to diameter ratios ranging from 10/1 to 50/1 can be used to melt blend the molten layer materials, the melt streams then metered to the die having a die gap(s) within the range of from 0.5 or 1 to an upper limit of 3 or 4 or 5 or 6 mm. The extruded film is then cooled using air, water, or both. Typically, a single, large diameter roll partially submerged in a water bath, or two large chill rolls set at 20 or 30 to 40 or 50 or 60 or 70° C. are suitable cooling means. As the film is extruded, an air knife and edge pinning are used to provide intimate contact between the melt and chill roll.

Downstream of the first cooling step in this embodiment of the tentered process, the unoriented film is reheated to a temperature of from 80 to 100 or 120 or 150° C., in one embodiment by any suitable means such as heated S-wrap rolls, and then passed between closely spaced differential speed rolls to achieve machine direction orientation. It is understood by those skilled in the art that this temperature range can vary depending upon the equipment, and in particular, upon the identity and composition of the components making up the film. Ideally, the temperature will be below that which will melt the film, but high enough to facilitate the machine direction orientation process. Such temperatures referred to herein refer to the film temperature itself. The film temperature can be measured by using, for example, infrared spectroscopy, the source aimed at the film as it is being processed; those skilled in the art will understand that for transparent films, measuring the actual film temperature will not be as precise. The heating means for the film line may be set at any appropriate level of heating, depending upon the instrument, to achieve the stated film temperatures.

The lengthened and thinned film is passed to the tenter section of the line for TD orientation. At this point, the edges of the sheet are grasped by mechanical clips on continuous chains and pulled into a long, precisely controlled hot air oven for a pre-heating step. The film temperatures range from 100 or 110 to 150 or 170 or 180° C. in the pre-heating step. Again, the temperature will be below that which will melt the film, but high enough to facilitate the step of transverse direction orientation. Next, the edges of the sheet are grasped by mechanical clips on continuous chains and pulled into a long, precisely controlled hot air oven for transverse stretching. As the tenter chains diverge a desired amount to stretch the film in the transverse direction, the process temperature is lowered by at least 2° C. but typically no more than 20° C. relative to the pre-heat temperature to maintain the film temperature so that it will not melt the film. After stretching to achieve transverse orientation in the film, the film is annealed at a temperature below the melting point, and the film is then cooled from 5 to 10 or 15 or 20 or 30 or 40° C. below the stretching temperature, and the clips are released prior to edge trim, optional coronal, printing and/or other treatment can then take place, followed by winding.

Thus, TD orientation is achieved by the steps of pre-heating the film having been machine oriented, followed by stretching and annealing it at a temperature below the melt point of the film, and then followed by a cooling step at yet a lower temperature. In one embodiment, the films described herein are formed by imparting a transverse orientation by a process of first pre-heating the film, followed by a decrease in the temperature of the process within the range of from 2 or 3 to 5 to 10 or 15 or 20° C. relative to the pre-heating temperature while performing transverse orientation of the film, followed by a lowering of the temperature within the range of from 5° C. to 10 or 15 or 20 or 30 or 40° C. relative to the melt point temperature, holding or slightly decreasing (more than 5%) the amount of stretch, to allow the film to anneal. The latter step imparts the low TD shrink characteristics of the films described herein. Thus, for example, where the pre-heat temperature is 120° C., the stretch temperature may be 114° C., and the cooling step may be 98° C., or any temperature within the ranges disclosed. The steps are carried out for a sufficient time to affect the desired film properties as those skilled in the art will understand.

Thus, in certain embodiments the film(s) described herein are biaxially oriented with at least a 5 or 6 or 7 or 11-fold TD orientation and at least a 2 or 3 or 7-fold MD orientation. Being so formed, the at least three-layer (one core, two skin layers, 18-21 μm thickness) possess an ultimate tensile strength within the range of from 100 or 110 to 80 or 90 or 250 MPa in the TD in certain embodiments; and possess an ultimate tensile strength within the range of from 30 or 40 to 150 or 130 MPa in the MD in other embodiments.

Notably, the shrink of the films and labels described herein have a shrink of ≤about 5% in any direction of orientation, and more preferably ≤about 4% or ≤about 3% if any shrink at all.

Further example embodiments are provided immediately below.

An oriented film, whether monoaxially or biaxially oriented, may include at least one layer having ≥about 5 wt. % through≤about 95 wt. % of a combination of virgin polypropylene and post-industrial reclaimed polypropylene, and the post-industrial reclaimed polypropylene has a melt flow index from about 0.5 g/min through about 15 g/min and a dispersion index from about 2 through 10, wherein filter pressure of the post-industrial reclaimed polypropylene≤about 20 bar/kg when using a 350-mesh filter on a COLLIN Teach Line Type FT-E20T extruder according to the method and settings in the description, wherein the oriented film is neither cavitated nor pigmented, and wherein the oriented film has a haze of about 50% or less. The at least one layer may be in a two-, three-, four-, five- or more-layered film.

The oriented film in the preceding paragraph may have the at least one layer located in the core layer, in one or more tie layer(s), or any combination thereof. Additionally and alternatively, the oriented film may include one or more additives in any its layer(s) or exclude the presence of any additives other than pigments and cavitating agents in any of its layers. Additives may include calcium carbonate, polybutylene terephthalate, or others as previously described in this disclosure. Furthermore, the core layer and/or its tie layer(s) may include one or more plastomers.

The virgin and reclaimed polypropylenes of the oriented film in the preceding paragraph may be high-crystalline polypropylene, isotactic polypropylene, syndiotactic polypropylene, PP copolymer, or combinations thereof.

The oriented film described in any of the three preceding paragraphs may include at least one skin layer comprising a copolymer and/or terpolymer of ethylene, propylene, and/or butylene polymers.

The oriented film described in any of the four preceding paragraphs may be a label, i.e., also optionally having the addition of any kind of adhesive to a surface of the oriented film and optionally a liner. Additionally and alternatively, the oriented film may have one or more coatings and/or be metallized.

The oriented film described in any of the five preceding paragraphs may be cast, blown, and/or coextruded.

The at least one layer in the oriented film described in any of the six preceding paragraphs may consist essentially of the industrial reclaimed polypropylene and/or consist of the industrial reclaimed polypropylene. The “and” in this case in when said oriented film may occur in at least two layers of said oriented film.

The oriented film described in any of the seven preceding paragraphs results in a stable production, i.e., the oriented film has no web breaks on a BOPP tenter manufacturing tenter line run from about 50 m/min through about 600 m/min at a temperature from about 80° C. through about 180° C., with a web width anywhere between about 1.5 m through about 10 m over a time period of about 1.5 h.

The post-industrial reclaimed polypropylene in the at least one layer in the oriented film described in any of the eight preceding paragraphs may be one or more coated films, e.g., one or more polyurethane-coated film(s), acrylic-coated film(s), EVOH-coated film(s), PVD coated film(s), PVD coated-on-AlOx layer film(s), other coated and/or metallized film(s), or combinations thereof.

The films, including labels, of the disclosed films and their equivalents may be about 25 μm or less in thickness, about 20 μm or less in thickness, about 15 μm or less in thickness, or in some embodiments, greater than about 25 μm in thickness.

### INDUSTRIAL APPLICABILITY

The disclosed multilayered films may be stand-alone films, laminates, or webs. Or, the multilayered films may be sealed, coated, metallized, and/or laminated to other film structures. The laminating substrate, itself, may for instance, be a BOPP or a non-oriented, cast or blown PP film or other polymer film with or without the assistance of adhesive(s), increases in temperature and/or pressure, water or solvents, etc.; furthermore, the laminating substrate may or may not be metallized and/or coated. The disclosed multilayered films may be prepared by any suitable methods comprising the steps of co-extruding a multilayered film according to the description and claims of this specification, orienting and preparing the film for intended use such as by coating, printing, slitting, or other converting methods.

For some applications, it may be desirable to laminate the multilayered films to other polymeric film or paper products for purposes such as package decor including printing and metallizing. These activities are typically performed by the ultimate end-users or film converters who process films for supply to the ultimate end-users.

The prepared multilayered film may be used as a flexible packaging film to package an article or good, such as a food item or other product. In some applications, the film may be formed into a pouch type of package, such as may be useful for packaging a beverage, liquid, granular, or dry-powder product.

While the foregoing is directed to example embodiments of the disclosed invention, other and further embodiments may be devised without departing from the basic scope thereof, wherein the scope of the disclosed compositions, systems and methods are determined by one or more claims.

What is claimed is:

1. An oriented film comprising:
at least one layer comprising ≥about 5 wt. % through≤about 95 wt. % of a combination of virgin polypropylene and post-industrial reclaimed polypropylene, and has a melt flow index from about 0.5 g/min through about 15 g/min and a dispersion index from about 2 through 10,
wherein filter pressure of the post-industrial reclaimed polypropylene≤about 20 bar/kg when using a 350-mesh filter on a COLLIN Teach Line Type FT-E20T extruder according to the method and settings in the description,
wherein the oriented film is neither cavitated nor pigmented,
wherein the oriented film has a haze of about 50% or less.

2. The oriented film of claim 1, wherein the at least one layer is a core layer of the oriented film.

3. The oriented film of claim 1, wherein the at least one layer is one or more tie layers of the oriented film.

4. The oriented film of claim 1, wherein the virgin polypropylene comprises high-crystalline polypropylene.

5. The oriented film of claim 1, wherein the virgin polypropylene comprises isotactic polypropylene.

6. The oriented film of claim 1, wherein the virgin polypropylene comprises at least two of random polypropylene, high-crystalline polypropylene, isotactic polypropylene, polypropylene homopolymer, polypropylene copolymer, and polypropylene terpolymer.

7. The oriented film of claim 1, wherein the oriented film is at least two layers.

8. The oriented film of claim 1, wherein the oriented film is at least four layers.

9. The oriented film of claim 1, wherein the oriented film has at least one skin layer comprising a copolymer and/or terpolymer comprising carbons from C1-C8, optionally in combination with one or more additives.

10. The oriented film of claim 1, wherein the oriented film comprises a core layer comprising the at least one layer and a plastomer.

11. The oriented film of claim 1, further comprising one or more additives.

12. The oriented film of claim 1, further comprising calcium carbonate.

13. The oriented film of claim 1, further comprising polybutylene terephthalate.

14. The oriented film of claim 1, wherein the oriented film is a label.

15. The oriented film of claim 1, wherein the at least one layer consists essentially of the post-industrial reclaimed polypropylene.

16. The oriented film of claim 1, wherein post-industrial reclaimed polypropylene comprises one or more coated films.

17. The oriented film of claim 1, wherein the post-industrial reclaimed polypropylene comprises one or more polyurethane-coated films.

18. The oriented film of claim 1, wherein the post-industrial reclaimed polypropylene comprises one or more acrylic-coated films.

19. The oriented film of claim 1, wherein the post-industrial reclaimed polypropylene comprises one or more EVOH-coated films.

20. The oriented film of claim 1, wherein the post-industrial reclaimed polypropylene comprises one or more PVD-coated films and/or one or more PVD-coated-on-AlOx layer films.
